(19) United States
(12) Patent Application Publication
(10) Pub. No.: US 2024/0126088 A1
(43) Pub. Date: Apr. 18, 2024

(54) POSITIONING METHOD, APPARATUS AND SYSTEM OF OPTICAL TRACKER

(71) Applicant: Beijing Zitiao Network Technology Co., Ltd., Beijing (CN)

(72) Inventors: Qinglin CHEN, Beijing (CN); Junliang SHAN, Beijing (CN); Hanzhen LI, Beijing (CN)

(21) Appl. No.: 18/472,014

(22) Filed: Sep. 21, 2023

(30) Foreign Application Priority Data
Oct. 8, 2022 (CN) 202211222475.6

(51) Int. Cl. G02B 27/01

(52) U.S. Cl. CPC G02B 27/0172; G02B 27/0101; G02B 2027/0138

(57) ABSTRACT

Embodiments of the present disclosure provides a positioning method, apparatus, and system of an optical tracker, which can be applied to a VR scene, where the VR scene includes an optical tracker and a headset device, the headset device includes a camera, and the optical tracker includes N LED lights, and the method includes: obtaining an infrared image of the optical tracker, where the infrared image includes respective light spots generated by M LED lights, with N≥M>1, reprojecting, for each group of LED lights in multiple groups of LED lights, a group of LED lights onto the infrared image to obtain corresponding reprojection coordinates of the group of LED lights, where each group of LED lights includes M LED lights, and determining a positioning distance between the optical tracker and the camera according to respective corresponding reprojection coordinates of each group of LED lights and the infrared images.

### CROSS-REFERENCE TO RELATED APPLICATIONS

This application claims priority to Chinese Patent Application No. 202211222475.6, filed on Oct. 8, 2022, which is hereby incorporated by reference in its entirety.

### TECHNICAL FIELD

Embodiments of the present disclosure relate to the fields of virtual reality and image processing technologies, and in particular, to a positioning method, apparatus, and system of an optical tracker.

### BACKGROUND

A working process of an optical tracker is a process of recording a movement of an object or a person, as well as a process of capturing motion. In order to render a user feels an immersive virtual world, it is usually necessary to position the optical tracker.

In some embodiments, the optical tracker can be positioned using a perspective N-point algorithm, for example, a positioning of the optical tracker is optimized by at least 3 pairs of three-dimensional to two-dimensional point pairs to obtain a positioning result.

However, the above method must be implemented according to at least 3 pairs of three-dimensional to two-dimensional point pairs, the optimization process is relatively complex, and the positioning efficiency is relatively low.

### SUMMARY

Embodiments of the present disclosure provide a positioning method, apparatus, and system of an optical tracker to overcome a problem that a positioning efficiency of the optical tracker is low.

In a first aspect, one or more embodiments of the present disclosure provide a positioning method of an optical tracker, which is applied to a virtual reality (VR) scene, where the VR scene includes an optical tracker and a headset device, the headset device includes a camera, the optical tracker includes N LED lights, and the method includes:
obtaining an infrared image of the optical tracker, where the infrared image includes respective light spots generated by M LED lights, N≥M>1;
reprojecting, for each group of LED lights in multiple groups of LED lights, a group of LED lights onto the infrared image to obtain corresponding reprojection coordinates of the group of LED lights, where each group of LED lights includes M LED lights; and
determining a positioning distance between the optical tracker and the camera according to respective corresponding reprojection coordinates of each group of LED lights and the infrared image.

In a second aspect, one or more embodiments of the present disclosure provide a positioning apparatus of an optical tracker, which is applied to a virtual reality (VR) scene, where the VR scene includes an optical tracker and a headset device, the headset device includes a camera, the optical tracker includes N LED lights, and the positioning apparatus of an optical tracker includes:
an obtaining unit, configured to obtain an infrared image of the optical tracker, where the infrared image includes respective light spots generated by M LED lights, N≥M>1;
a reprojecting unit, configured to reproject, for each group of LED lights in multiple groups of LED lights, a group of LED lights onto the infrared image to obtain corresponding reprojection coordinates of the group of LED lights, where each group of LED lights includes M LED lights; and
a determining unit, configured to determine a positioning distance between the optical tracker and the camera according to respective corresponding reprojection coordinates of each group of LED lights and the infrared image.

In a third aspect, one or more embodiments of the present disclosure provide an electronic device, which includes at least one processor and a memory;
a computer execution instruction is stored in the memory;
the at least one processor executes the computer execution instruction stored in the memory to cause the at least one processor to execute the positioning method of an optical tracker as described in the first aspect and various possible designs of the first aspect.

In a fourth aspect, one or more embodiments of the present disclosure provide a computer readable storage medium, a computer execution instruction is stored thereon, and the positioning method of an optical tracker described in the first aspect and various possible designs of the first aspect are implemented when the computer execution instruction is executed by a processor.

According to a fifth aspect of the present disclosure, a computer program product including a computer program is provided, where the computer program is stored on a readable storage medium, at least one processor of an electronic device can read the computer program from the readable storage medium, the at least one processor executes the computer program to cause the electronic device to implement the positioning method of an optical tracker described in the first aspect.

According to a sixth aspect of the present disclosure, a positioning system of an optical tracker is provided, which includes a headset device, an optical tracker, and the positioning apparatus of an optical tracker as described in the second aspect.

The positioning method, apparatus, and system of an optical tracker provided in the embodiments can be applied to a VR scene, where the VR scene includes an optical tracker and a headset device, the headset device includes a camera, the optical tracker includes N LED lights, and the method includes: obtaining an infrared image of the optical tracker, where the infrared image includes respective light spots generated by M LED lights, N≥M>1, reprojecting, for each group of LED lights in multiple groups of LED lights, a group of LED lights onto the infrared image to obtain corresponding reprojection coordinates of the group of LED lights, where each group of LED lights includes M LED lights, and determining a positioning distance between the optical tracker and the camera according to respective corresponding reprojection coordinates of each group of LED lights and the infrared image, which can avoid a defect of high complexity caused by a positioning based on at least 3 pairs of points pairs, save a computational resource, and improve positioning efficiency.

### BRIEF DESCRIPTION OF DRAWINGS

In order to explain the embodiments of the present disclosure or the technical solutions in the related art more clearly, the drawings needed to be used in the embodiments or the description of the related art will be introduced briefly in the following. Obviously, the drawings in the following description are some embodiments of the present disclosure. For those of ordinary skill in the art, other drawings can also be obtained from these drawings without paying creative effort.

FIG. 1 is a schematic diagram of a scene of one or more embodiments of the present disclosure.

FIG. 2 is a schematic flowchart of a positioning method of an optical tracker of one or more embodiments of the present disclosure.

FIG. 3 is a schematic flowchart of a positioning method of an optical tracker of another one or more embodiments of the present disclosure.

FIG. 4 is a schematic diagram of a positioning apparatus of an optical tracker of one or more embodiments of the present disclosure.

FIG. 5 is a schematic diagram of a positioning apparatus of an optical tracker of another one or more embodiments of the present disclosure.

FIG. 6 is a schematic structural diagram of hardware of an electronic device provided by one or more embodiments of the present disclosure.

### DESCRIPTION OF EMBODIMENTS

To make the purposes, technical solutions, and advantages of embodiments of the present disclosure more clearly, the technical solutions in the embodiments of the present disclosure are clearly and completely described in the following with reference to the drawings of the embodiments of the present disclosure. Obviously, the described embodiments are part of embodiments of the present disclosure, not all embodiments. Based on the embodiments of the present disclosure, all other embodiments obtained by those skilled in the art without creative effort are all within the protection scope of the present disclosure.

To facilitate a reader understands the present disclosure, at least some terminologies used in the present disclosure are explained as follows:
Virtual Reality (VR) technology is also known as a virtual environment technology or a virtual reality technology, which includes computer, electronic information, and simulation technologies. Its basic implementation is mainly based on the computer technology, utilize and integrate various high-tech technologies, such as, three dimensional graphics technology, multimedia technology, simulation technology, display technology, and servo technology, and have the aid of computers and other devices to generate a realistic virtual world with three-dimension visual sense, touch sense, smell sense, and multiple sense experiments, and thereby creating an immersive feeling for people in the virtual world.
Headset device is also known as head mounted virtual reality glasses, or a VR head display (Virtual Reality Head Mounted Display for short), generally shaped as a helmet, and for guiding to create a feeling of being in a VR virtual three-dimensional (3D) environment for a user.
Euclidean distance, which is also known as Euclidean metric, is a distance definition, and refers to a true distance between two points in the m (m is a positive integer greater than or equal to 2) dimensional space.
Homogeneous coordinate refers to a representation of a vector that is originally n (n is a positive integer greater than or equal to 2) dimensions as an n+1 dimension vector.
Camera intrinsic parameter describes a corresponding relationship between a point in a camera coordinate system and the point in an image coordinate system (also known as a pixel coordinate system).
Perspective-n-Point (PnP) algorithm refers to a corresponding method for solving between a 3D point to a two-dimensions (2D) point based on an optimization algorithm. It describes how to estimate a position and orientation of an object to be estimated (such as a camera) when 3D positions of a multiple of points are known.

For example, if there are two images, the 3D position of a point in one image is known, then at least three groups of 3D-2D point pairs (and at least one additional verification point is needed to verify a result) are required to calculate the motion of a camera.

A working process of an optical tracker is a process of recording a movement of an object or a person, as well as a process of capturing motion. In a VR scene, the optical tracker can be a handle or a component of the handle, it refers to an optical positioning tracker for facilitating a user's experience of an immersive virtual world. The optical tracker has an interaction function, and an interaction mode includes capturing motion and gesture tracking.

Exemplary, a user's motion can be captured using the optical tracker, and the user's gesture can also be tracked using the optical tracker. In order to capture the user's motion or track the user's gesture, the optical tracker can be positioned first.

In some embodiments, a positioning of the optical tracker can be achieved based on the PnP algorithm. In combination with the above explanation of the terminologies of PnP algorithm, it can be seen that a positioning method of an optical tracker based on PnP algorithm includes: obtaining an image of the optical tracker, if the position of a 2D point in the image of the optical tracker corresponding to that of a 3D point of the camera is known, then the position of the optical tracker can be calculated and obtained by continuously optimized and iterated based on at least three pairs of 3D to 2D points pairs (and at least one additional verification point pair to verify the result).

However, for the position of the optical tracker calculated by using the above method, the calculation is relatively complexity, and the positioning efficiency is relatively low.

In order to avoid at least one of the above technical problems, inventors of the present disclosure obtain an inventive concept of the present disclosure through creative effort: an optical tracker is equipped with N LED lights, the N LED lights including multiple groups of LED lights, each group of LED lights including M LED lights, and the infrared image of the optical tracker obtained through capturing including respective light spots generated by the M LED lights, obtaining, for each group of LED lights, a reprojection image of the group of LED lights that are reprojected onto the infrared image, and calculating a distance between the optical tracker and the camera by combining the infrared image and respective reprojection images to achieve the positioning of the optical tracker, N≥M>1.

The following is a detailed explanation of the technical solution of the present disclosure and how it solves the above technical problems through specific embodiments. The following specific embodiments can be combined with each other, and the same or similar concepts or processes may not be repeated in some embodiments. The following will describe the embodiments of the present disclosure in combination with the drawings.

According to one or more embodiments of the present disclosure, the present disclosure provides a positioning method of an optical tracker, which is applied to a VR scene, where the VR scene includes an optical tracker and a headset device connected by communication, the headset device includes a camera, and the optical tracker includes a multiple of LED lights.

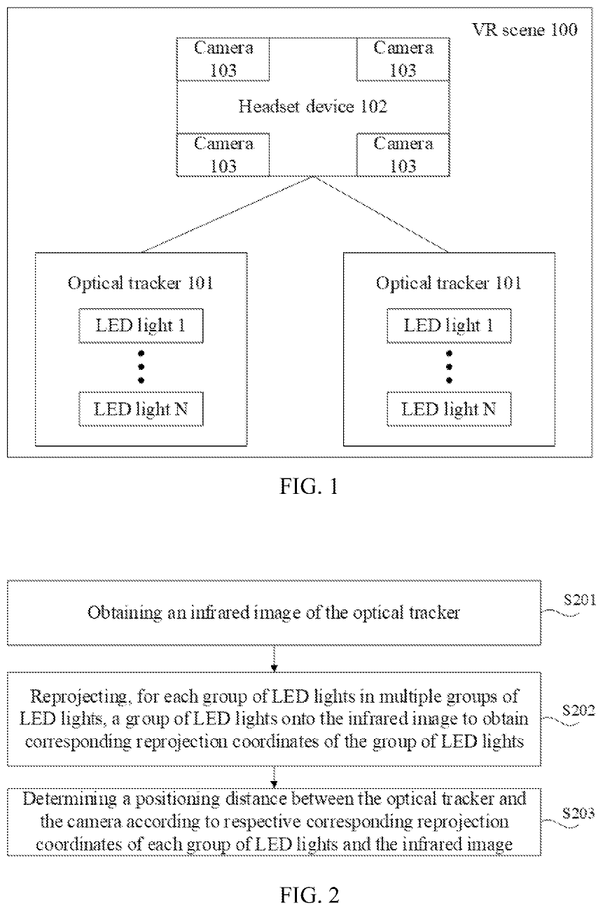

Exemplary, FIG. 1 is a schematic diagram of a VR scene 100 of one or more embodiments of the present disclosure. As shown in FIG. 1, the VR scene includes an optical tracker 101 and a headset device 102.

The embodiments do not make limitation on the number of the optical tracker 101. For example, the number of the optical tracker 101 can be one or two. If the number of the optical trackers 101 is two, and generally speaking, the two optical trackers 101 are located on both sides of the headset device 102. One optical tracker 101 corresponds to a user's left hand, and the other optical tracker 101 corresponds to the user's right hand. The user can operate the optical tracker 101, for example, controlling a forward and backward movement of a virtual object in a VR game scene through the optical tracker 101.

The optical tracker 101 includes a multiple of LED lights, and the number of LED lights can be determined according to requirements, historical records, experiments, etc., which is not limited in the embodiments.

As shown in FIG. 1, the optical tracker 101 includes a LED light 1 up to a LED light N, that is, the optical tracker 101 includes N (N is a positive integer greater than or equal to 2) LED lights.

The headset device 102 is worn on a user's head. The headset device 102 includes a camera 103, and the number of the cameras can be multiple. Similarly, the number of the camera can be determined according to requirements, historical records, and experiments, which is not limited in the embodiments. As shown in FIG. 1, the headset device 101 including four cameras 103 is demonstratively shown as an example.

In some embodiments, the headset device can be a VR all-in-one machine.

The positioning method of an optical tracker of the present disclosure is now demonstratively elaborated in combination with FIG. 2. Where, FIG. 2 is a schematic flowchart of a positioning method of an optical tracker of one or more embodiments of the present disclosure.

As shown in FIG. 2, this method includes:
S201: obtaining an infrared image of the optical tracker, where the infrared image includes respective light spots generated by M LED lights, N≥M>1.

An executive subject of the embodiments can be a positioning apparatus of an optical tracker (hereinafter referred to as the positioning apparatus), which can be a headset device in a VR scene, and it can specifically be a processor deployed on the headset device or a chip deployed on the headset device, which is not limited in the embodiments.

In combination with FIG. 1 and the above analysis, the headset device includes a camera, and the camera can be an infrared camera. Correspondingly, an image of the optical tracker can be collected according to the camera, and the image can be referred to as an infrared image.

Due to the fact that the optical tracker includes N LED lights, and the LED light can generate an infrared light. When the infrared image of an optical tracker is captured by the camera, an infrared image of the LED light that generates an infrared light can be collected, and the infrared light generated by the LED light appears as a light spot in the infrared image.

Thus, in the infrared image, the light spot is actually obtained by imaging the infrared light generated by the LED light, and the light spot in this infrared image can represent the LED light in the VR scene. That is, the light spot can be understood as an imaging content of the infrared light that is generated by the LED light in the infrared image.

In the embodiments, the infrared image can include respective light spots that are generated by at least a part (i.e., M) of the LED lights.

Where, if two LED lights in the optical tracker are visible relative to the camera, the infrared image collected by the camera includes the light spots generated by the two LED lights; and if multiple LED lights in the optical tracker are visible relative to the camera, the infrared image collected by the camera includes respective light spots generated by the multiple of LED lights.

S202: reprojecting, for each group of LED lights in multiple groups of LED lights, a group of LED lights onto the infrared image to obtain corresponding reprojection coordinates of the group of LED lights, where each group of LED lights includes M LED lights.

In some embodiments, multiple groups of LED lights can be determined according to random arrangement of N and M, such as A_{N}^{M} groups of LED lights can be determined, and A is an arrangement.

Exemplary, as for each group of LED lights of the A_{N}^{M} groups of LED lights, they are reprojected, and reprojected onto the infrared image to obtain respective corresponding reprojection coordinates of each group of LED lights.

S203: determining a positioning distance between the optical tracker and the camera according to respective corresponding reprojection coordinates of each group of LED lights and the infrared image.

Exemplary, each group of LED lights in the multiple groups of LED lights are reprojected on the infrared image of the optical tracker to obtain corresponding reprojection coordinates of the group of LED lights, if the number of the multiple groups are A_{N}^{M} groups, then respective corresponding reprojection coordinates of A_{N}^{M} groups of LED lights are obtained, that is, A_{N}^{M} groups of reprojection coordinates are obtained.

Correspondingly, the reprojection coordinates of the A_{N}^{M} groups are subjected to coordinate transformation calculating to obtain the positioning distance according to the infrared image.

When a positioning result can be obtained using the above method to position the optical tracker, where the positioning result can include the positioning distance, that is, a distance between the optical tracker and the camera.

Based on the above analysis, the present disclosure provides a positioning method of an optical tracker, which is applied to a VR scene, where the VR scene includes an optical tracker and a headset device, the headset device includes a camera, the optical tracker includes N LED lights, and the method includes: obtaining an infrared image of the optical tracker, where the infrared image includes respective light spots generated by M LED lights, N≥M>1, reprojecting, for each group of LED lights in multiple groups of LED lights, a group of LED lights onto the infrared image to obtain corresponding reprojection coordinates of the group of LED lights, where each group of LED lights includes M LED lights, and determining a positioning distance between the optical tracker and the camera according to respective corresponding reprojection coordinates of each group of LED lights and the infrared image. In the embodiments, through technical features of determining that multiple groups of LED lights each including M LED lights, reprojecting each group of LED lights onto the infrared image to obtain respective corresponding reprojection coordinates of each group of LED lights and calculating a positioning distance according to the respective corresponding reprojection coordinates of each group of LED lights and the infrared image, which can avoid a defect of high complexity caused by a positioning based on at least 3 pairs of 3D-2D point pairs, save a computational resource, and improve positioning efficiency.

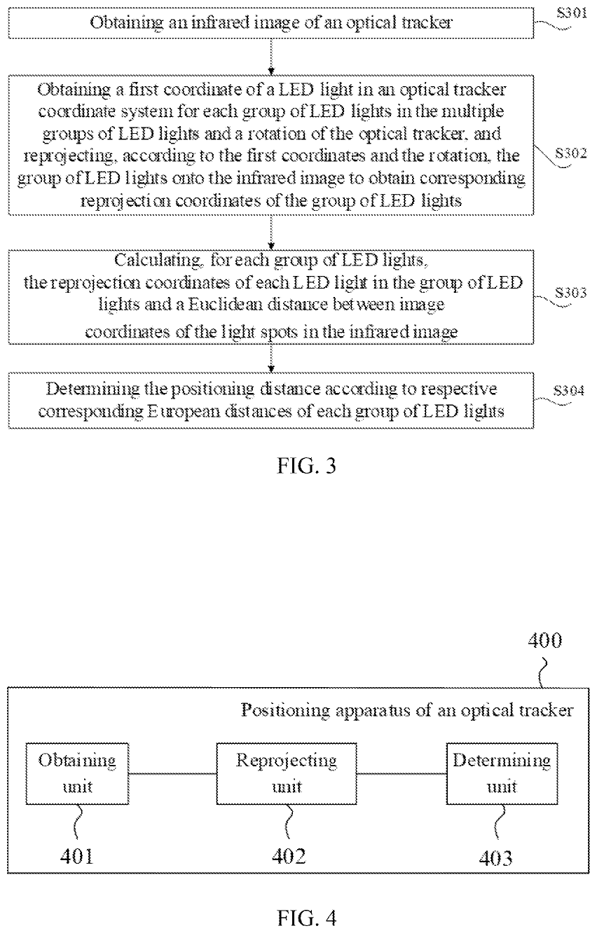

In order to make a reader deeply understand an implementation principle of the present disclosure, the positioning method of an optical tracker of the present disclosure is now elaborated in more detail in combination with FIG. 3. Similarly, this method can be applied to a VR scene, which includes an optical tracker and a headset device, the headset device includes a camera, and the optical tracker includes N LED lights.

Where, FIG. 3 is a schematic flowchart of a positioning method of an optical tracker of another one or more embodiments of the present disclosure.

As shown in FIG. 3, this method includes:
S301: obtaining an infrared image of an optical tracker, where the infrared image includes respective light spots generated by multiple groups of LED lights, N≥M>1.

It should be understood that, in order to avoid tedious statements, the same technical features as in the above embodiments will not be repeated in this embodiment.

S302: obtaining a first coordinate of a LED light in an optical tracker coordinate system for each group of LED lights in the multiple groups of LED lights and a rotation of the optical tracker, and reprojecting, according to the first coordinates and the rotation, the group of LED lights onto the infrared image to obtain corresponding reprojection coordinates of the group of LED lights, where, each group of LED lights includes M LED lights.

Where, the first coordinate refers to a coordinate of the LED light in the optical tracker coordinate system. The first coordinate can be determined according to an installation process of the LED light on the optical tracker, that is, when the LED light is installed on the optical tracker, the coordinate of the LED light in the optical tracker coordinate system has been determined.

It should be understood that “first” in the first coordinate is used to distinguish it from other coordinates in this embodiment (such as, the reprojection coordinate, etc.), and cannot be understood as limiting to the first coordinate.

The rotation can be determined according to a sensor that is deployed on the optical tracker.

Exemplary, if an inertial measurement unit (IMU) is deployed on the optical tracker, the rotation is determined according to a sensor data collected by the IMU.

Where, a positioning result obtained by positioning the optical tracker can be represented by a position and orientation, where the position and orientation can include a rotation and a displacement. That is, in this embodiment, the position and orientation of the optical tracker include the rotation of the optical tracker (as determined according to IMU in the above embodiments) and the positioning distance.

Since positions of different groups of LED lights in the optical tracker are different (i.e., the first coordinates of different LED lights are different), based on that different groups of LED lights on the positions of the optical tracker are reprojected, the determined reprojection coordinates for different groups of LED lights are also different.

Exemplary, in combination with the above analysis, if M equals to 2, that is, two light spots are included in the infrared image. If a first group of LED lights includes two LED lights, and for ease of distinguishing, these two LED lights are referred to as a first LED light and a second LED light, then a reprojection coordinate of the first LED light after reprojecting and a reprojection coordinate of the second LED light after reprojecting can be obtained by reprojecting the first LED light and second LED light onto the infrared image according to the first coordinate of the first LED light (i.e., a coordinate of the first LED light in the optical tracker coordinate system), the first coordinate of the second LED light (i.e., a coordinate of the second LED light in the optical tracker coordinate system), and the rotation.

Similarly, a second group of LED lights includes two LED lights, and for ease of distinguishing, these two LED lights can be referred to as a third LED light and a fourth LED light, then a reprojection coordinate of the third LED light after reprojecting and a reprojection coordinate of the fourth LED light after reprojecting can be obtained by reprojecting the third LED light and the fourth LED light onto the infrared image according to the first coordinate of the third LED light (i.e., a coordinate of the third LED light in the optical tracker coordinate system), the first coordinate of the fourth LED light (i.e., a coordinate of the fourth LED light in the optical tracker coordinate system) and the rotation.

It should be understood that the above example is demonstratively explained a possible value of M with M being 2, and cannot be understood as a limitation on M, and the above examples are only demonstratively explained that respective corresponding reprojection coordinates for each group of LED lights may be different by taking two groups of LED lights as an example, and cannot be understood as a limitation on the number the groups of LED lights.

In some embodiments, each LED light in the multiple groups of LED lights is a LED light, which can be captured by the camera and determined according to the rotation of the optical tracker and an obtained relative direction between the optical tracker and the camera.

Exemplary, the infrared images include a light spot, and the number of the light spots is multiple. The number of light spots represents the number of LED light that is captured in the infrared image.

For example, due to the position of the optical tracker and other reasons, some LED lights on the optical tracker may not be captured by the camera. If a certain LED light is not captured, there is no light spot generated by the LED light in the infrared image. If the certain LED light is captured, the light spot generated by the LED light is included in the infrared image.

In this embodiment, the optical tracker includes N LED lights, and each LED light of the multiple groups of LED lights for positioning is an LED light that can be captured by the camera. The LED light that can be captured by the camera can be determined according to the rotation and the obtained relative direction between the optical tracker and the camera.

The LED light has an identification. When the LED light that can be captured by the camera and determined according to the rotation and the obtained relative direction between the optical tracker and the camera, an identification of the LED light that can be captured by the camera can be determined. In order to distinguish the identification of the LED light that can be captured by the camera from the identification of other LED lights, the identification of the LED light that can be captured by the camera can be called a target identification.

That is to say, each LED light has an identification, and one group of LED lights of the multiple groups of LED lights corresponds to a group of identification lists. The identifications in each group of identification lists are the identification of LED lights, which can be captured by the camera and determined according to the rotation and the obtained relative direction between the optical tracker and the camera.

Exemplary, an infrared image may include respective light spots generated by multiple LED lights. In a case that it is impossible to determine which LED light generates the light spots in the infrared image, the positioning apparatus can generate a group of LED lights that may generate light spots according to the target identification, so as to determine the group of light spots generated in the infrared image from each group of LED lights.

For example, in some embodiments, each LED light can be assigned its corresponding identification first, and the identifier corresponding to the LED light that can be captured by the camera is determined from each identifier according to the rotation and relative direction. For ease of distinguishing, this part of identification can be referred to as the target identification, and LED lights with target identifications can be grouped.

Where, all LED lights marked as the target identification can be grouped, and a part of the LED lights marked as the target identification can also be grouped.

Exemplary, in combination with FIG. 1 and the above examples that are analyzed with the FIG. 1, if N LED lights are deployed on the optical tracker, each LED light can be assigned an identification (ID) by the positioning apparatus (or a staff) to distinguish different LED lights according to the identification. For example, the identification of N LED lights is from identification 1 to identification N.

Where, the positioning apparatus can randomly assign corresponding identifications, when assigning respective corresponding identifications for the N LED lights, for example, the positioning apparatus assigns respective corresponding identifications for the N LED lights independently of the position of N LED lights on the optical tracker and the like. And this embodiment does not make limitation on a method of generating an identification by the positioning apparatus.

For example, if N equals to 16, that is, the number of LED lights deployed on the optical tracker is 16, the positioning apparatus can assign an identification for each of the 16 LED lights from identification 0 to identification 15, and the respective corresponding identification for the 16 LED lights is unique.

The identification of the LED light can be captured by the camera is determined according to the rotation and the relative direction. If the determined identification is [2, 3, 4, 5, 6, 7, 8, 9, 10, 11, 12, 13, 14, 15], then this part of identification can be called the target identification.

In some embodiments, if M equals to 3, that is, respective light spots generated by the 3 LED lights are included in the infrared image, multiple groups of identification lists can be generated according to an arrangement of the above 14 target identifications. Each group of identification lists includes three different target identifications, that is, each group of identification lists corresponds to a group of LED lights, and a group of LED lights includes three different LED lights.

Exemplary, in combination with the above analysis, A₁₄³ groups of identification lists can be generated after an arrangement.

For example, the A₁₄³ groups of identification lists generated according to the above 14 target identifications include [2, 3, 4], [2, 3, 5], [3, 4, 5], [3, 5, 7] . . . etc.

It should be understood that the above four groups of identification lists are only used to demonstratively illustrate a possible implementation mode of the identification lists, and cannot be understood as limiting on the identification lists.

Correspondingly, each group of identification lists corresponds to a group of LED lights, for example, the group of identification lists [2, 3, 4] corresponds to a group of LED lights of [LED light identified as 2, LED light identified as 3, LED light identified as 4], and so on, and it will not be listed one by one herein.

If a certain LED light cannot be captured by the camera, there is no light spot generated by the LED light included in the infrared image. Thus, in this embodiment, by determining the LED light captured by the camera according to the rotation and the relative direction, it can avoid introducing a LED light that cannot be captured by the camera into a useless solving of the positioning, and render each group of identification lists has high reliability, so as to render the group of identification lists of LED lights that generate light spots in the infrared images according to matching each group of identification lists has high reliability, thereby improving the positioning effectiveness.

In some embodiments, the reprojecting, according to the first coordinates and the rotation, the group of LED lights onto the infrared image to obtain corresponding reprojection coordinates of the group of LED lights includes the following steps.

A first step: calculating a first distance between the optical tracker and the camera according to the first coordinates, the infrared image, and the rotation.

The first distance refers to a distance between the optical tracker and the camera. Similarly, it should be understood that “first” in the “first distance” is used to distinguish it from other distances (such as a positioning distance) in the below description and cannot be understood as a limitation on the first distance.

A second step: reprojecting, according to the rotation and the first distance, the group of LED lights onto the infrared image to obtain the corresponding reprojection coordinates of the group of LED lights.

In this embodiment, for different groups, respective corresponding first distances for different groups are determined according to the first coordinates of different groups of LED lights, respective corresponding reprojection coordinates for each group are obtained according to the respective corresponding first distances of each group, which can make the determined reprojection coordinates of each group have strong pertinence, thereby improving the effectiveness and reliability of the respective reprojection coordinates.

In some embodiments, the first step may include the following substep.

A first sub step: converting an image coordinate of a light spot in the infrared image to a Homogeneous coordinate in a camera coordinate system.

In combination with the above example, if the infrared image includes respective light spots generated by M LED lights, then each light spot has an image coordinate.

Accordingly, the image coordinate is converted into the Homogeneous coordinate for the image coordinate of each light spot in the M light spots.

Exemplary, each image coordinate can be subject to anti-distortion processing and normalization processing to convert each image coordinate to the camera coordinate system and obtain the Homogeneous coordinate in the camera coordinate system.

In some embodiments, image coordinate P_{img} can be transformed to the Homogeneous coordinate through Equation 1, and the Equation 1 is as the following:

P_{C}=K⁻¹P_{img}
where, K is a camera intrinsic parameter.

A second substep: calculating a first distance according to the first coordinates, the rotation, and the Homogeneous coordinate.

In this embodiment, the Homogeneous coordinates is obtained by converting the image coordinate, and the first distance is calculated by combining the first coordinate and the rotation. The Homogeneous coordinates is a coordinate of a light spot corresponding to the camera coordinate system, the first distance is a distance between the optical tracker and the camera, and the rotation is a parameter of the optical tracker relative to a position and orientation of the camera, that is, these three parameters have a strong correlation with the distance between the optical tracker and the camera. Thus, the first distance has high accuracy and reliability by calculating it through these three parameters.

In some embodiments, the second substep may include the following refinement steps.

A first refinement step: constructing a coefficient matrix according to the Homogeneous coordinate.

Exemplary, if the infrared image includes respective light spots generated by M LED lights, then the Homogeneous coordinate P_{C} can be represented as P_{Ci}(uᵢ, vᵢ, 1), 1≤i≤M, u is the horizontal coordinate, v is the vertical coordinate, and l is the longitudinal coordinate.

Correspondingly, a coefficient matrix B can be represented by Equation 2, and the Equation 2 is as following:

$$B = [ \begin{matrix}1 & 0 & - {u}_{1} \\ 0 & 1 & - {v}_{1} \\ 1 & 0 & - {u}_{2} \\ 0 & 1 & - {v}_{2} \\ ⋮ & ⋮ & ⋮ \\ 1 & 0 & - {u}_{N} \\ 0 & 1 & - {v}_{N}\end{matrix} ]$$

A second refinement step: constructing a constant matrix according to the rotation, the first coordinate, and the Homogeneous coordinate.

In some embodiments, the coefficient matrix C can be represented by Equation 3, and the Equation 3 is as following:

$$C = [ \begin{matrix}( R [ 6 ] * {u}_{1} - R [ 0 ] ) + {P}_{I 1} [ 0 ] + ) R [ 7 ] * {u}_{1} - R [ 1 ] ) * {P}_{I 1} [ 1 ] + ( R [ 8 ] * {u}_{1} - R [ 2 ] ) * {P}_{I 1} [ 2 ] \\ ( R [ 6 ] * {v}_{1} - R [ 3 ] ) + {P}_{I 1} [ 0 ] + ) R [ 7 ] * {v}_{1} - R [ 4 ] ) * {P}_{I 1} [ 1 ] + ( R [ 8 ] * {v}_{1} - R [ 5 ] ) * {P}_{I 1} [ 2 ] \\ ( R [ 6 ] * {u}_{1} - R [ 0 ] ) + {P}_{I 2} [ 0 ] + ) R [ 7 ] * {u}_{1} - R [ 1 ] ) * {P}_{I 2} [ 1 ] + ( R [ 8 ] * {u}_{1} - R [ 2 ] ) * {P}_{I 2} [ 2 ] \\ ( R [ 6 ] * {v}_{1} - R [ 3 ] ) + {P}_{I 2} [ 0 ] + ) R [ 7 ] * {v}_{1} - R [ 4 ] ) * {P}_{I 2} [ 1 ] + ( R [ 8 ] * {v}_{1} - R [ 5 ] ) * {P}_{I 2} [ 2 ] \\ ⋮ \\ ( R [ 6 ] * {u}_{1} - R [ 0 ] ) + {P}_{IN} [ 0 ] + ) R [ 7 ] * {u}_{1} - R [ 1 ] ) * {P}_{IN} [ 1 ] + ( R [ 8 ] * {u}_{1} - R [ 2 ] ) * {P}_{IN} [ 2 ] \\ ( R [ 6 ] * {v}_{1} - R [ 3 ] ) + {P}_{IN} [ 0 ] + ) R [ 7 ] * {v}_{1} - R [ 4 ] ) * {P}_{IN} [ 1 ] + ( R [ 8 ] * {v}_{1} - R [ 5 ] ) * {P}_{IN} [ 2 ]\end{matrix} ]$$

where, R is the rotation, which can be represented by R [0] to R [8], P_{I} is the first coordinate, P_{Ii} is the first coordinate of the i^{th} LED light.

A third refinement step: calculating a first distance according to the coefficient matrix and the constant matrix.

In some embodiments, the first distance t can be calculated according to Equation 4, and Equation 4 is as following:

t=(B^{T}B)⁻¹B^{T}C
where, T is transpose.

In some embodiments, the second step may include the following substeps.

A first substep: determining a second coordinate of the group of LED lights in a camera coordinate system according to the rotation and the first distance.

In some embodiments, the second coordinate F_{C} can be calculated according to Equation 5, and Equation 5 is as following:

F_{C}=T_{CI}P_{I}
where, T_{CI} is the position and orientation of the optical tracker corresponding to the group of LED lights, and T_{CI} includes the rotation and the first distance.

A second substep: calculating corresponding reprojection coordinates of the group of LED lights according to the second coordinate and the camera intrinsic parameter.

In some embodiments, the reprojection coordinate F_{Proj} can be calculated according to Equation 6, and the Equation 6 is as following:

F_{Proj}=KF_{c}
where, K is the camera intrinsic parameter.

In this embodiment, the second coordinate of the optical tracker in the camera coordinate system is first determined to calculate the reprojection coordinate in combination with the camera intrinsic parameter, which renders the calculated reprojection coordinate has high accuracy and reliability.

S303: calculating, for each group of LED lights, the reprojection coordinates of each LED light in the group of LED lights and a Euclidean distance between image coordinates of the light spots in the infrared image.

Exemplary, if the image coordinate of a certain light spot in the infrared image is (x₁, y₁), and the first group of LED lights includes LED light a, the reprojection coordinate of LED light a is (x₂, y₂), then the image coordinate of a certain light spots and the Euclidean distance p a between the reprojection coordinates of the LED light a can be calculated according to Equation 7, and the Equation 7 is as following:

ρₐ=\sqrt{(x₂−x₁)²+(y₂−y₁)²}

S304: determining the positioning distance according to respective corresponding European distances of each group of LED lights.

In this embodiment, at least two light spots in the infrared image can be used to obtain the positioning distance. Compared to the calculated positioning distance using at least three pairs of 3D-2D point pairs, the computational complexity is relatively lower, which can reduce a computational resource of the positioning apparatus, and due to a reduction of the computational complexity, an operating speed of the positioning apparatus is relatively faster, thereby improving the positioning efficiency.

In some embodiments, S304 may include the following steps.

Step 1: calculating an average value of corresponding Euclidean distances of each group of LED lights.

Exemplary, the average value corresponding to that group of LED lights can be calculated after calculating the Euclidean distance corresponding to each LED light in each group of LED lights.

Step 2: obtaining a minimum average value from the average values and determining the first distance corresponding to the minimum average value as the positioning distance.

The smaller the Euclidean distance between the reprojection coordinate and the image coordinate, the smaller the difference between the reprojection coordinate and the image coordinate, that is, the closer of the distance between the reprojection coordinate and the image coordinate. The average value is determined according to the Euclidean distance, and the Euclidean distance is determined according to the first distance. Thus, relatively speaking, the smaller the average value, the more accurate of the first distance that is used to calculate the Euclidean distance corresponding to the average value, and thus, the determined positioning distance can have high accuracy and reliability by determining the second distance corresponding to the minimum average as the positioning distance.

According to one or more embodiments of the present disclosure, the present disclosure further provides a positioning apparatus of an optical tracker, which can be applied to a virtual reality (VR) scene, where the VR scene includes an optical tracker and a headset device, the headset device includes a camera, and the optical tracker includes multiple LED lights.

Referring to FIG. 4, which is a schematic diagram of a positioning apparatus of an optical tracker of one or more embodiments of the present disclosure.

As shown in FIG. 4, the positioning apparatus of an optical tracker 400 includes:
an obtaining unit 401, configured to obtain an infrared image of the optical tracker, where the infrared image includes respective light spots generated by M LED lights, N≥M>1;
a reprojecting unit 402, configured to reproject, for each group of LED lights in multiple groups of LED lights, a group of LED lights onto the infrared image to obtain corresponding reprojection coordinates of the group of LED lights, where each group of LED lights includes M LED lights; and
a determining unit 403, configured to determine a positioning distance between the optical tracker and the camera according to respective corresponding reprojection coordinates of each group of LED lights and the infrared image.

Referring to FIG. 5, which is a schematic diagram of a positioning apparatus of an optical tracker of another one or more embodiments of the present disclosure.

As shown in FIG. 5, the positioning apparatus of an optical tracker 500 includes:
an obtaining unit 501, configured to obtain an infrared image of the optical tracker, where the infrared image includes respective light spots generated by M LED lights, N≥M>1; and
a reprojecting unit 502, configured to reproject, for each group of LED lights in the multiple LED lights, a group of LED lights onto the infrared image to obtain corresponding reprojection coordinates of the group of LED lights, where each group of LED lights includes M LED lights.

In some embodiments, in combination with FIG. 5, it can be seen that the reprojecting unit 502 includes:
an obtaining subunit 5021, configured to obtain first coordinates of the group of LED lights in an optical tracker coordinate system and a rotation of the optical tracker; and
a reprojecting subunit 5022, configured to reproject, according to the first coordinates and the rotation, the group of LED lights onto the infrared image to obtain corresponding reprojection coordinates of the group of LED lights.

In some embodiments, the reprojecting unit 5022 includes:
a first calculating module, configured to calculate a first distance between the optical tracker and the camera according to the first coordinate, the infrared image, and the rotation.

In some embodiments, the first calculating module includes:
a conversing submodule, configured to convert an image coordinate of a light spot in the infrared image into a Homogeneous coordinate in a camera coordinate system; and
a first calculating submodule, configured to calculate a first distance according to the first coordinate, the rotation, and the Homogeneous coordinate.

The reprojecting unit 5022 further includes a reprojecting module, configured to reproject, according to the rotation and the first distance, the group of LED lights onto the infrared image to obtain corresponding reprojection coordinates of the group of LED lights.

In some embodiments, the reprojecting module includes:
a determining submodule, configured to determine second coordinates of the group of LED lights in a camera coordinate system according to the rotation and the first distance; and
a second calculating submodule, configured to calculate corresponding reprojection coordinates of the group of LED lights according to the second coordinate and a camera intrinsic parameter of the camera.

As shown in FIG. 5, the positioning apparatus of an optical tracker 500 further includes a determining unit 503, configured to determine a positioning distance between the optical tracker and the camera according to respective corresponding reprojection coordinates of each group of LED lights and the infrared image.

In some embodiments, in combination with FIG. 5, it can be seen that the determining unit 503 includes:
a calculating subunit 5031, configured to calculate, for each group of LED lights, the reprojection coordinates of each LED light in the group of LED lights and a Euclidean distance between image coordinates of the light spots in the infrared image; and
a determining subunit 5032, configured to determine the positioning distance according to respective corresponding Euclidean distances of each group of LED lights.

In some embodiments, the determining subunit 5032 includes:
a second calculating module, configured to calculate an average value of the corresponding Euclidean distances of each group of LED lights; and
a determining module, configured to obtain a minimum average value from respective average values and determine a first distance corresponding to the minimum average value as the positioning distance.

In some embodiments, each LED light of multiple groups of LED lights is an LED light that can be captured by the camera and determined according to a rotation of the optical tracker and an obtained relative direction between the optical tracker and the camera.

In some embodiments, each LED light has an identification, and each group of LED lights corresponds to a group of identification lists, the identifications in each group of identification lists are identifications of the LED lights that can be captured by the camera and determined according to the rotation and the obtained relative direction between the optical tracker and the camera.

According to one or more embodiments of the present disclosure, the present disclosure further provides a positioning system of an optical tracker, which includes a headset device, an optical tracker, and the positioning apparatus of an optical tracker as described in any one of the above embodiments.

In some embodiments, the positioning apparatus of an optical tracker may be a component of the headset device. Exemplary, the positioning apparatus of an optical tracker is deployed on the headset device.

In some embodiments, the headset device can be a VR all-in-one machine.

In some embodiments, the headset device includes a camera.

In some embodiments, the optical tracker includes a multiple of LED lights, and multiple groups of LED lights can be captured by the camera, and at least one LED light is included in a group of LED lights.

According to one or more embodiments of the present disclosure, the present disclosure further provides an electronic device and a readable storage medium.

According to one or more embodiments of the present disclosure, the present disclosure further provides a computer program product, which includes a computer program, and the computer program is stored in the readable storage medium, at least one processor of an electronic device can read the computer program from the readable storage medium, and at least one processor executes the computer program to cause the electronic device to execute the technical solution provided in any one of the above embodiments.

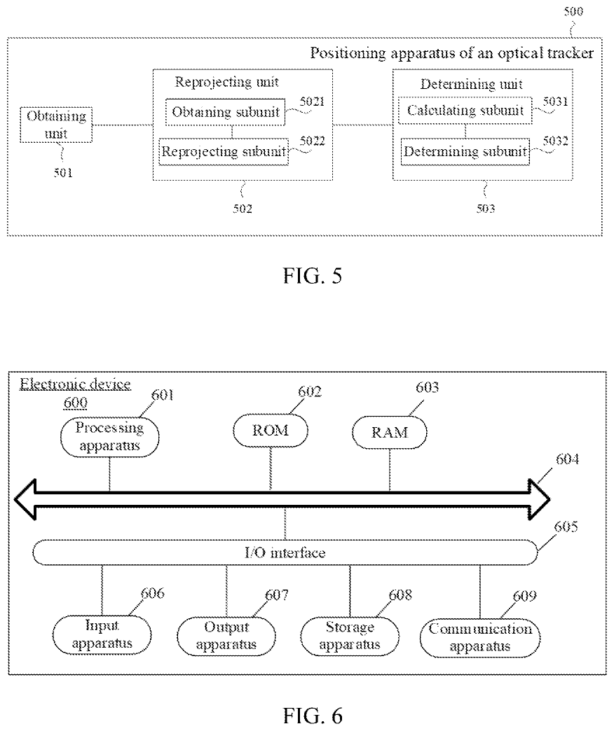

Referring to FIG. 6, which shows a schematic structural diagram of an electronic device 600 suitable for implementing one or more embodiments of the present disclosure, where the electronic device 600 can be a terminal device or a server. Where, the terminal device can include, but is not limited to, a mobile terminal, such as, a mobile phone, a laptop, a digital radio receiver, a personal digital assistant (PDA), a portable android device (PAD), a portable media player (PMP), a vehicle-mounted terminal (such as a vehicle-mounted navigation terminal) and other mobile terminals, and a fixed terminal, such as a digital TV, a desktop computer, etc. The electronic device shown in FIG. 6 is only an example and should not impose any limitations on the functionality and use scope of the embodiments of the present disclosure.

As shown in FIG. 6, the electronic device 600 may include a processing apparatus 601 (such as a central processing unit, a graphics processor, etc.) that can perform various appropriate actions and processes based on a program stored in read only memory (ROM) 602 or a program loaded from a storage apparatus 608 into a random access memory (RAM) 603. In the RAM 603, various programs and data required for an operation of the electronic device 600 are also stored. The processing apparatus 601, the ROM 602, and the RAM 603 are connected to each other through a bus 604. An input/output (I/O) interface 605 is also connected to the bus 604.

Usually, the following apparatuses can be connected to the I/O interface 605: an input apparatus 606 including, such as, a touch screen, a touchpad, a keyboard, a mouse, a camera, a microphone, an accelerometer, a gyroscope, etc.; an output apparatus 607 including, such as, a Liquid Crystal Display (LCD), a speaker, a vibrator, etc.; a storage apparatus 608, including, such as, a magnetic tape, a hard disk drive, etc.; and a communication apparatus 609. The communication apparatus 609 can allow the electronic device 600 to conduct wireless or wired communication with other devices to exchange data. Although FIG. 6 illustrates the electronic device 600 having various apparatuses, it should be understood that it is not required to implement or possess all shown apparatuses. It can be implemented alternatively or have more or fewer apparatuses.

Specifically, according to one or more embodiments of the present disclosure, a process described above with reference to the flowchart can be implemented as a computer software program. For example, one or more embodiments of the present disclosure include a computer program product that includes a computer program hosted on a computer-readable medium, and the computer program includes a program code for executing the method shown in the flowchart. In such embodiments, the computer program can be downloaded from network and installed through the communication apparatus 609, or installed from the storage apparatus 608, or installed from the ROM 602. When the computer program is executed by the processing apparatus 601, the above-mentioned functions defined in the method of one or more embodiments of the present disclosure are executed.

It should be noted that, the above-mentioned computer readable medium in the present disclosure may be a computer readable signal medium or a computer readable storage medium or a combination of the both. The computer readable storage medium may be, for example, but not limited to, an electrical, a magnetic, an optical, an electromagnetic, an infrared, or a semiconductor system, apparatus or device, or any combination of the above. More specific examples of the computer readable storage medium may include, but are not limited to: an electrical connection with one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the above. In the present disclosure, a computer readable storage medium may be any tangible medium that contains or stores a program, and the program may be used by or in combination with an instruction executive system, apparatus, or device. In the present disclosure, a computer readable signal medium may include a data signal propagated in a baseband or as a part of a carrier wave, and a computer readable program code is carried therein. This propagated data signal may adopt many forms, including but not limited to, an electromagnetic signal, an optical signal, or any suitable combination of the above. The computer readable signal medium may also be any computer readable media other than the computer readable storage medium, and the computer readable signal medium may send, propagate, or transmit the program used by or in combination with the instruction executive system, apparatus, or device. The program code contained on the computer readable medium may be transmitted by any suitable medium, including but not limited to: a wire, an optical cable, a RF (Radio Frequency), etc., or any suitable combination of the above.

The above-mentioned computer readable medium may be included in the above-mentioned electronic device; or it may exist alone without being assembled into the electronic device.

The above-mentioned computer readable medium carries one or more programs, and when the above-mentioned one or more programs are executed by the electronic device, the electronic device is caused to execute the method shown in above embodiments.

The computer program code used to perform operations of the present disclosure may be written in one or more programming languages or a combination thereof. The above-mentioned programming languages include object-oriented programming languages, such as Java, Smalltalk, C++, and also include conventional procedural programming languages, such as “C” language or similar programming languages. The program code may be executed entirely on a computer of a user, partly on a computer of a user, executed as an independent software package, partly executed on a computer of a user and partly executed on a remote computer, or entirely executed on a remote computer or a server. In a case where a remote computer is involved, the remote computer may be connected to the computer of the user through any kind of network, including a local area network (LAN) or a wide area network (WAN), or it may be connected to an external computer (for example, use an Internet service provider to connect via the Internet).

The flowcharts and block diagrams in the drawings illustrate possible implementation architecture, functions, and operations of the system, method, and computer program product in accordance with the embodiments of the present disclosure. At this point, each block in the flowchart or the block diagram may represent a module, a program segment, or a part of code, and the module, the program segment, or the part of code contains one or more executable instructions for implementing a specified logical function. It should also be noted that, in some alternative implementations, the functions marked in the blocks may also occur in a different order from the order marked in the drawings. For example, two blocks shown one after another may actually be executed substantially in parallel, or sometimes may be executed in a reverse order, which depends on the functions involved. It should also be noted that, each block in the block diagram and/or flowchart, and a combination of the blocks in the block diagram and/or flowchart, may be implemented by a dedicated hardware-based system that performs the specified functions or operations, or may be implemented by a combination of dedicated hardware and computer instructions.

The units involved in the embodiments described in the present disclosure may be implemented in software or hardware. Where a name of the unit does not constitute a limitation on the unit itself in some cases. For example, the first obtaining unit may also be described as “a unit that acquires at least two Internet Protocol addresses”.

The functions described above herein can be at least partially executed by one or more hardware logic components. For example, unrestrictedly, usable exemplary types of the hardware logic components include: a field programmable gate array (FPGA), an application specific integrated circuit (ASIC), an application specific standard product (ASSP), a system on chip (SOC), or a complex programmable logic device (CPLD), and so on.

In the context of the present disclosure, a machine readable medium may be a tangible medium that may contain or store programs for use by or in combination with an instruction executive system, apparatus or device. The machine readable medium may be a machine readable signal medium or a machine readable storage medium. The machine readable medium may include, but is not limited to, an electronic, a magnetic, an optical, an electromagnetic, an infrared, or a semiconductor system, apparatus or device, or any suitable combination of the above. More specific examples of the machine readable storage medium will include an electrical connection based on one or more lines, a portable computer disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination of the above.

In a first aspect, according to one or more embodiments of the present disclosure, a positioning method of an optical tracker is provided, which is applied to a virtual reality (VR) scene, the VR scene includes an optical tracker and a headset device, the headset includes a camera, the optical tracker includes N LED lights, and the method includes:
obtaining an infrared image of the optical tracker, where the infrared image includes respective light spots generated by M LED lights, N≥M>1;
reprojecting, for each group of LED lights in multiple groups of LED lights, a group of LED lights onto the infrared image to obtain corresponding reprojection coordinates of the group of LED lights, where each group of LED lights includes M LED lights; and
determining a positioning distance between the optical tracker and the camera according to respective corresponding reprojection coordinates of each group of LED lights and the infrared image.

According to one or more embodiments of the present disclosure, the reprojecting the group of LED lights onto the infrared image to obtain the corresponding reprojection coordinates of the group of LED lights includes:
obtaining first coordinates of a group LED lights in an optical tracker coordinate system and a rotation of the optical tracker; and
reprojecting, according to the first coordinates and the rotation, the group of LED lights onto the infrared image to obtain the corresponding reprojection coordinates of the group of LED lights.

According to one or more embodiments of the present disclosure, the reprojecting, according to the first coordinates and the rotation, the group of LED lights onto the infrared image to obtain corresponding reprojection coordinates of the group of LED lights includes:
calculating a first distance between the optical tracker and the camera according to the first coordinates, the infrared image, and the rotation; and
reprojecting, according to the rotation and the first distance, the group of LED lights onto the infrared image to obtain the corresponding reprojection coordinates of the group of LED lights.

According to one or more embodiments of the present disclosure, the calculating the first distance between the optical tracker and the camera according to the first coordinates, the infrared image, and the rotation includes:
converting an image coordinate of a light spot in the infrared image into a Homogeneous coordinate in a camera coordinate system; and
calculating the first distance according to the first coordinates, the rotation, and the Homogeneous coordinate.

According to one or more embodiments of the present disclosure, the reprojecting, according to the rotation and the first distance, the group of LED lights onto the infrared image to obtain the corresponding reprojection coordinates of the group of LED lights includes:
determining second coordinates of the group of LED lights in a camera coordinate system according to the rotation and the first distance; and
calculating the corresponding reprojection coordinates of the group of LED lights according to the second coordinate and the camera intrinsic parameter of the camera.

According to one or more embodiments of the present disclosure, the determining the positioning distance between the optical tracker and the camera according to respective corresponding reprojection coordinates of each group of LED lights and the infrared image includes:
calculating, for each group of LED lights, the reprojection coordinates of each LED light in the group of LED lights and a Euclidean distance between image coordinates of the light spots in the infrared image; and
determining the positioning distance according to respective corresponding Euclidean distances of each group of LED lights.

According to one or more embodiments of the present disclosure, the determining the positioning distance according to respective corresponding Euclidean distances of each group of LED lights includes:
calculating an average value of the corresponding Euclidean distances of each group of LED lights; and
obtaining a minimum average value from respective average values and determining a first distance corresponding to the minimum average value as the positioning distance.

According to one or more embodiments of the present disclosure, each LED light of multiple groups of LED lights is an LED light that can be captured by the camera and determined according to a rotation of the optical tracker and an obtained relative direction between the optical tracker and the camera.

According to one or more embodiments of the present disclosure, each LED light has an identification, and each group of LED lights corresponds to a group of identification lists, the identifications in each group of identification lists are identifications of the LED lights that can be captured by the camera and determined according to the rotation and the obtained relative direction between the optical tracker and the camera.

In a second aspect, according to one or more embodiments of the present disclosure, a positioning apparatus of an optical tracker is provided, which is applied to a virtual reality (VR) scene, the VR scene includes an optical tracker and a headset device, the headset device includes a camera, the optical tracker includes N LED lights, and the apparatus includes:
an obtaining unit, configured to obtain an infrared image of the optical tracker, where the infrared image includes respective light spots generated by M LED lights, N≥M>1;
a reprojecting unit, configured to reproject, for each group of LED lights in multiple groups of LED lights, a group of LED lights onto the infrared image to obtain corresponding reprojection coordinates of the group of LED lights, where each group of LED lights includes M LED lights; and
a determining unit, configured to determine a positioning distance between the optical tracker and the camera according to respective corresponding reprojection coordinates of each group of LED lights and the infrared image.

According to one or more embodiments of the present disclosure, the reprojecting unit includes:
an obtaining subunit, configured to obtain first coordinates of the group of LED lights in an optical tracker coordinate system and a rotation of the optical tracker; and
a reprojecting subunit, configured to reproject, according to the first coordinates and the rotation, the group of LED lights onto the infrared image to obtain corresponding reprojection coordinates of the group of LED lights.

According to one or more embodiments of the present disclosure, the reprojecting subunit includes:
a first calculating module, configured to calculate a first distance between the optical tracker and the camera according to the first coordinate, the infrared image, and the rotation; and
a reprojecting module, configured to reproject, according to the rotation and the first distance, the group of LED lights onto the infrared image to obtain corresponding reprojection coordinates of the group of LED lights.

According to one or more embodiments of the present disclosure, the first calculating module includes:
a conversing submodule, configured to convert an image coordinate of a light spot in the infrared image into a Homogeneous coordinate in a camera coordinate system; and
a first calculating submodule, configured to calculate a first distance according to the first coordinate, the rotation, and the Homogeneous coordinate.

According to one or more embodiments of the present disclosure, the reprojecting module includes:
a determining submodule, configured to determine second coordinates of the group of LED lights in a camera coordinate system according to the rotation and the first distance; and
a second calculating submodule, configured to calculate corresponding reprojection coordinates of the group of LED lights according to the second coordinate and a camera intrinsic parameter of the camera.

According to one or more embodiments of the present disclosure, the determining unit includes:
a calculating subunit, configured to calculate, for each group of LED lights, the reprojection coordinates of each LED light in the group of LED lights and a Euclidean distance between image coordinates of the light spots in the infrared images; and
a determining subunit, configured to determine the positioning distance according to respective corresponding Euclidean distances of each group of LED lights.

According to one or more embodiments of the present disclosure, the determining subunit includes:
a second calculating module, configured to calculate an average value of the corresponding Euclidean distances of each group of LED lights; and
a determining module, configured to obtain a minimum average value from respective average values and determine a first distance corresponding to the minimum average value as the positioning distance.

According to one or more embodiments of the present disclosure, each LED light of multiple groups of LED lights is an LED light that can be captured by the camera and determined according to a rotation of the optical tracker and an obtained relative direction between the optical tracker and the camera.

According to one or more embodiments of the present disclosure, each LED light has an identification, and each group of LED lights corresponds to a group of identification lists, the identifications in each group of identification lists are identifications of the LED lights that can be captured by the camera and determined according to the rotation and the obtained relative direction between the optical tracker and the camera.

In a third aspect, according to one or more embodiments of the present disclosure, an electronic device is provided, which includes at least one processor and a memory;
a computer execution instruction is stored in the memory; and
the at least one processor executes the computer execution instruction stored in the memory to cause the at least one processor to execute the positioning method of an optical tracker as described in the first aspect and various possible designs of the first aspect.

In a fourth aspect, according to one or more embodiments of the present disclosure, a computer readable storage medium is provided, a computer execution instruction is stored thereon, and the positioning method of an optical tracker described in the first aspect and various possible designs of the first aspect are implemented when the computer execution instruction is executed by a processor.

According to a fifth aspect of the present disclosure, a computer program product is provided, which includes a computer program, where the computer program is stored on a readable storage medium, at least one processor of an electronic device can read the computer program from the readable storage medium, the at least one processor executes the computer program to cause the electronic device to execute the positioning method of an optical tracker described in the first aspect.

According to a sixth aspect of the present disclosure, a positioning system of an optical tracker is provided, which includes a headset device, an optical tracker, and the positioning apparatus of an optical tracker as described in the second aspect.

The above description is only preferred embodiments of the present disclosure and an illustration of the applied technical principles. Those skilled in the art should understand that, the disclosure scope involved in the present disclosure is not limited to the technical solutions formed by the specific combination of the above technical features, but also covers other technical solutions formed by the arbitrary combination of the above technical features or their equivalent features without departing from the above disclosure concept, for example, a technical solution formed by replacing the above features with technical features with similar functions disclosed (but not limited to) in the present disclosure.

In addition, although each operation is described in a specific order, this should not be understood as requiring these operations to be performed in the specific order or in a sequential order shown. Under certain circumstances, multitasking and parallel processing may be advantageous. Similarly, although several specific implementation details are included in the above discussion, these should not be interpreted as limiting the scope of the present disclosure. Certain features described in the context of a single embodiment may also be implemented in combination in the single embodiment. Conversely, various features described in the context of a single embodiment may also be implemented in multiple embodiments individually or in any suitable sub combination.

Although the subject matter has been described in a language specific to structural features and/or method logical actions, it should be understood that the subject matter defined in the appended claims is not limited to the specific features or actions described above. On the contrary, the specific features and actions described above are only exemplary forms for implementing the claims.

What is claimed is:

1. A positioning method of an optical tracker, applied to a virtual reality (VR) scene, wherein the VR scene comprises an optical tracker and a headset device, the headset device comprises a camera, the optical tracker comprises N LED lights, and the method comprises:
obtaining an infrared image of the optical tracker, wherein the infrared image comprises respective light spots generated by M LED lights, N≥M>1;
reprojecting, for each group of LED lights in multiple groups of LED lights, a group of LED lights onto the infrared image to obtain corresponding reprojection coordinates of the group of LED lights, wherein each group of LED lights comprises M LED lights;
determining a positioning distance between the optical tracker and the camera according to respective corresponding reprojection coordinates of each group of LED lights and the infrared image.

2. The method according to claim 1, wherein the reprojecting the group of LED lights onto the infrared image to obtain the corresponding reprojection coordinates of the group of LED lights comprises:
obtaining first coordinates of the group of LED lights in an optical tracker coordinate system and a rotation of the optical tracker;
reprojecting, according to the first coordinates and the rotation, the group of LED lights onto the infrared image to obtain the corresponding reprojection coordinates of the group of LED lights.

3. The method according to claim 2, wherein the reprojecting, according to the first coordinates and the rotation, the group of LED lights onto the infrared image to obtain the corresponding reprojection coordinates of the group of LED lights comprises:
calculating a first distance between the optical tracker and the camera according to the first coordinates, the infrared image, and the rotation;
reprojecting, according to the rotation and the first distance, the group of LED lights onto the infrared image to obtain the corresponding reprojection coordinates of the group of LED lights.

4. The method according to claim 3, wherein the calculating the first distance between the optical tracker and the camera according to the first coordinates, the infrared image, and the rotation comprises:
converting an image coordinate of a light spot in the infrared image into a Homogeneous coordinate in a camera coordinate system;
calculating the first distance according to the first coordinates, the rotation, and the Homogeneous coordinate.

5. The method according to claim 3, wherein the reprojecting, according to the rotation and the first distance, the group of LED lights onto the infrared image to obtain the corresponding reprojection coordinates of the group of LED lights comprises:
determining second coordinates of the group of LED lights in a camera coordinate system according to the rotation and the first distance;
calculating the corresponding reprojection coordinates of the group of LED lights according to the second coordinates and a camera intrinsic parameter of the camera.

6. The method according to claim 1, wherein the determining the positioning distance between the optical tracker and the camera according to respective corresponding reprojection coordinates of each group of LED lights and the infrared image comprises:
calculating, for each group of LED lights, the reprojection coordinates of each LED light in the group of LED lights and a Euclidean distance between image coordinates of light spots in the infrared image;
determining the positioning distance according to respective corresponding Euclidean distances of each group of LED lights.

7. The method according to claim 6, wherein the determining the positioning distance according to respective corresponding Euclidean distances of each group of LED lights comprises:
calculating an average value of the corresponding Euclidean distances of each group of LED lights;
obtaining a minimum average value from respective average values and determining a first distance corresponding to the minimum average value as the positioning distance.

8. The method according to claim 1, wherein, each LED light of multiple groups of LED lights is an LED light that is captured by the camera and determined according to a rotation of the optical tracker and an obtained relative direction between the optical tracker and the camera.

9. A positioning apparatus of an optical tracker, applied to a virtual reality (VR) scene, wherein the VR scene comprises an optical tracker and a headset device, the headset device comprises a camera, the optical tracker comprises N LED lights, and the positioning apparatus of an optical tracker comprises:
at least one processor and a memory;
a computer execution instruction is stored in the memory;
the at least one processor executes the computer execution instruction stored in the memory to cause the at least one processor to:
obtain an infrared image of the optical tracker, wherein the infrared image comprises respective light spots generated by M LED lights, N≥M>1;
reproject, for each group of LED lights in multiple groups of LED lights, a group of LED lights onto the infrared image to obtain corresponding reprojection coordinates of the group of LED lights, wherein each group of LED lights comprises M LED lights;
determine a positioning distance between the optical tracker and the camera according to respective corresponding reprojection coordinates of each group of LED lights and the infrared image.

10. The positioning apparatus according to claim 9, wherein the at least one processor is further configured to:
obtain first coordinates of the group of LED lights in an optical tracker coordinate system and a rotation of the optical tracker;
reproject, according to the first coordinates and the rotation, the group of LED lights onto the infrared image to obtain the corresponding reprojection coordinates of the group of LED lights.

11. The positioning apparatus according to claim 10, wherein the at least one processor is further configured to:
calculate a first distance between the optical tracker and the camera according to the first coordinates, the infrared image, and the rotation;
reproject, according to the rotation and the first distance, the group of LED lights onto the infrared image to obtain the corresponding reprojection coordinates of the group of LED lights.

12. The positioning apparatus according to claim 11, wherein the at least one processor is further configured to:
convert an image coordinate of a light spot in the infrared image into a Homogeneous coordinate in a camera coordinate system;
calculate the first distance according to the first coordinates, the rotation, and the Homogeneous coordinate.

13. The positioning apparatus according to claim 11, wherein the at least one processor is further configured to:
determine second coordinates of the group of LED lights in a camera coordinate system according to the rotation and the first distance;
calculate the corresponding reprojection coordinates of the group of LED lights according to the second coordinates and a camera intrinsic parameter of the camera.

14. The positioning apparatus according to claim 9, wherein the at least one processor is further configured to:
calculate, for each group of LED lights, the reprojection coordinates of each LED light in the group of LED lights and a Euclidean distance between image coordinates of light spots in the infrared image;
determine the positioning distance according to respective corresponding Euclidean distances of each group of LED lights.

15. The positioning apparatus according to claim 14, wherein the at least one processor is further configured to:
calculate an average value of the corresponding Euclidean distances of each group of LED lights;
obtain a minimum average value from respective average values and determine a first distance corresponding to the minimum average value as the positioning distance.

16. The positioning apparatus according to claim 9, wherein each LED light of multiple groups of LED lights is an LED light that is captured by the camera and determined according to a rotation of the optical tracker and an obtained relative direction between the optical tracker and the camera.

17. A non-transitory computer readable storage medium, applied to a virtual reality (VR) scene, wherein the VR scene comprises an optical tracker and a headset device, the headset device comprises a camera, the optical tracker comprises N LED lights, wherein a computer execution instruction is stored on the computer readable storage medium, and the computer execution instruction is used to cause a computer to perform the following steps:
obtaining an infrared image of the optical tracker, wherein the infrared image comprises respective light spots generated by M LED lights, N≥M>1;
reprojecting, for each group of LED lights in multiple groups of LED lights, a group of LED lights onto the infrared image to obtain corresponding reprojection coordinates of the group of LED lights, wherein each group of LED lights comprises M LED lights;
determining a positioning distance between the optical tracker and the camera according to respective corresponding reprojection coordinates of each group of LED lights and the infrared image.

18. The non-transitory computer readable storage medium according to claim 17, wherein the computer is further caused to perform the following steps:
obtaining first coordinates of the group of LED lights in an optical tracker coordinate system and a rotation of the optical tracker;
reprojecting, according to the first coordinates and the rotation, the group of LED lights onto the infrared image to obtain the corresponding reprojection coordinates of the group of LED lights.

19. The non-transitory computer readable storage medium according to claim 18, wherein the computer is further caused to perform the following steps:
calculating a first distance between the optical tracker and the camera according to the first coordinates, the infrared image, and the rotation;
reprojecting, according to the rotation and the first distance, the group of LED lights onto the infrared image to obtain the corresponding reprojection coordinates of the group of LED lights.

20. A positioning system of an optical tracker, comprising: a headset device, an optical tracker, and the positioning apparatus of an optical tracker according to claim 9.
